(19) United States
(12) Patent Application Publication
(10) Pub. No.: US 2008/0278544 A1
(43) Pub. Date: Nov. 13, 2008

(54) FLUID INJECTION DEVICE AND METHOD FOR FABRICATING AND OPERATING THEREOF

(75) Inventors: Chung-Cheng Chou, Taoyuan County (TW); Wai Wang, Taoyuan County (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 11/960,552

(22) Filed: Dec. 19, 2007

(30) Foreign Application Priority Data
May 7, 2007 (TW) TW96116089

(51) Int. Cl. B41J 2/04; B23P 17/00

(52) U.S. Cl. 347/54; 29/890.1

(57) ABSTRACT

A fluid injection device and a method for fabricating and operating thereof are provided. The fluid injection device comprises a first substrate having an actuator thereon, a second substrate correspondingly disposed on the first substrate to form a nozzle and a fluid channel. A deformable unit having a first volume is formed in the fluid channel. A fluid is sandwiched between the first and second substrates and surrounds the deformable unit and the actuator. In the fluid injection device, the deformable unit is transformed from the first volume to a second volume to control direction and size of droplet ejected from the nozzle.

### BACKGROUND OF THE INVENTION

1. Field of the Invention

The invention relates to fluid injection devices, and more particularly to a fluid injection device capable of controlling ejected droplet's size and direction, and a method for fabricating and operating thereof.

2. Description of the Related Art

As the development of inkjet printer printing techniques advance, demand for higher quality and higher resolution inkjet printers increase. Generally, quality and resolution of printed images are related to ejected droplet's performance such as flying speed, size, direction, etc.

FIG. 1 is a cross section of a conventional fluid injection device 1. Referring to FIG. 1, a first substrate 2, on which a heater 4 is formed thereon, is provided. Next, a second substrate 6 is then disposed on the first substrate 2. A fluid 10 such as ink is sandwiched between the first substrate 2 and the second substrate 6. The fluid 10 is heated by heater 4 to generate a bubble 8 for ejecting a droplet 12. Because the ejected flow of the droplet is not precisely controlled, the conventional fluid injection device has relatively inferior printing quality and resolution. Moreover, because the conventional fluid injection device can not precisely control the direction of droplet ejection, in efforts to raise printing quality and resolution, the amount of nozzles with various sizes can be increased and specific driving methods can be developed, however, fabrication cost would increase.

Thus, a fluid injection device capable of controlling ejected droplet's size and direction and method for fabricating and operating thereof is needed to increase printing quality and resolution.

### BRIEF SUMMARY OF INVENTION

The invention provides a fluid injection device. An exemplary embodiment of the fluid injection device comprises a first substrate having an actuator formed thereon, a second substrate correspondingly disposed on the first substrate to form a nozzle, a deformable unit between the first substrate and the second substrate, and a fluid between the first substrate and the second substrate and surrounding the deformable unit and the actuator. In the fluid injection device, the deformable unit further comprises a first electrode, a second electrode and a deformable layer, in which the first electrode is in contact with the deformable layer and the second electrode electrically connects to the deformable layer by the fluid.

Also, the invention provides a method for fabricating a fluid injection device. The method includes providing a first substrate having an actuator formed thereon, disposing a second substrate on the first substrate to form a fluid channel and a nozzle, forming a deformable unit in the fluid channel, and providing a fluid in the fluid channel and surrounding the deformable unit and the actuator.

The invention further provides a method for operating a fluid injection device comprising a fluid surrounding a deformable unit and an actuator. The operation method includes providing a pressure to the fluid by the actuator to eject a droplet, and transforming the deformable unit from a first volume to a second volume to control an ejected direction or flow of the droplet.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a cross section of a conventional fluid injection device;

FIGS. 2A-2F are cross sections of a method for fabricating a fluid injection device according to a first embodiment; and

FIGS. 3A-3D are cross sections of a method for fabricating a fluid injection device according to a second embodiment.

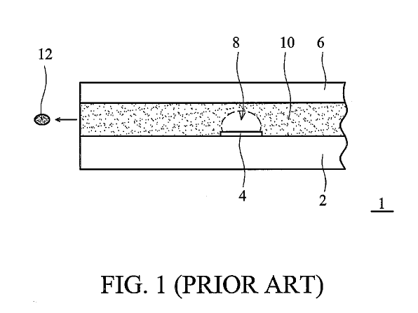

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

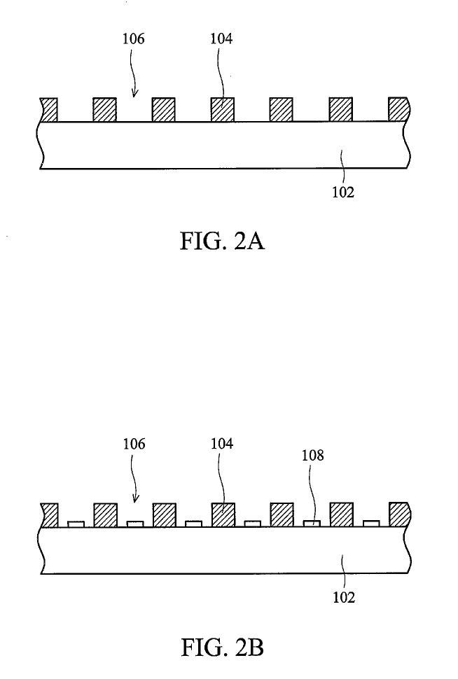

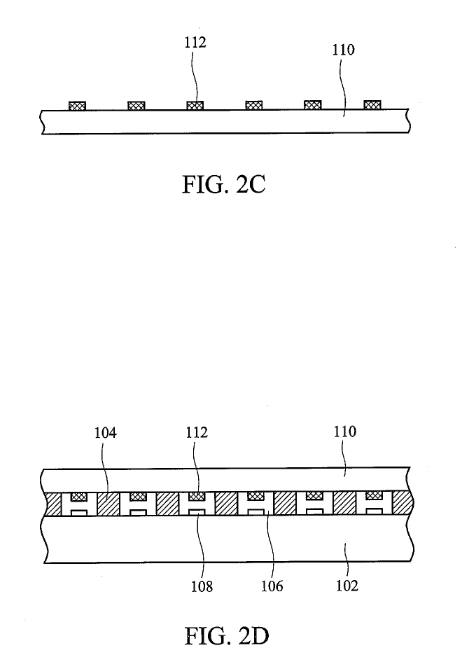

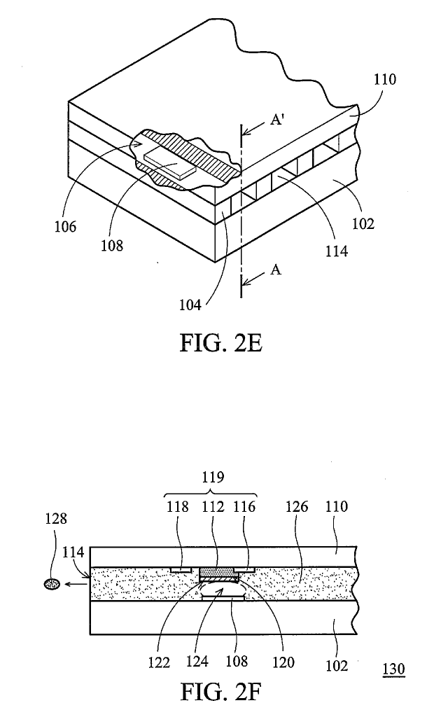

FIGS. 2A through 2F are sketch views of a method for fabricating a fluid injection device according to a first embodiment of the invention. Referring to FIG. 2A, a first substrate 102 is provided with a channel wall 104 formed thereon. A fluid channel 106 is formed between the channel walls 104. Preferably, the first substrate 102 is a material such as silicon and the channel wall 104 is a material such as acrylic acid ester or any suitable dry film photoresist. In one embodiment, a dry film photoresist layer (may also be referred to as a dry film) is formed on the first substrate 102 by coating. Next, the dry film photoresist layer is subsequently patterned by photolithography and etching to form the channel wall 104 and the fluid channel 106.

In FIG. 2B, an actuator 108 is subsequently formed on the fluid channel 106 for providing a bubble to the fluid injection device. Preferably, the actuator 108 is a heater consisted of a resistor layer made of, for example hafnium diboride (HfB2), tantalum aluminum (TaAl), or titanium nitride (TiN). In one embodiment, the resistor layer is conformingly formed on the first substrate 102 and the channel wall 104 by sputtering or evaporating. Next, a portion of the resistor layer is then removed by photolithography and etching to form the actuator 108 on the first substrate 102 between the channel walls 104.

Referring to FIG. 2C, a second substrate 110, on which a deformable layer 112 is formed is provided. Preferably, the deformable layer 112 is a conjugated conducting polymer such as polypyrrole, polyaniline, polysulfone, polythiophenes or polyacetylene. The second substrate 110 may preferably be silicon or other suitable material.

In one embodiment, a conductive layer (not shown) is formed on the second substrate 110 prior to forming the deformable layer 112. A conducting polymer layer is subsequently formed on the second substrate 110 and covers the conductive layer by dip coating, spin coating or electrochemical deposition. Next, the conducting polymer layer is patterned by photolithography and etching to form the deformable layer 112. In some embodiments, a monomer of the conducting polymer is directly formed at a desirable place on the second substrate 110 by electropolymerization or inkjet printing.

The conductive layer may serve as an electrode and along with the deformable layer 112 constitute a deformable unit. Preferably, the conductive layer is a conductive material made of gold (Au) or other suitable material. In an exemplary embodiment, an ion is provided to the deformable layer 112 by the electrode and the deformable layer 112 is then changed to oxidation or reduction state, so that an original volume of the deformable layer 112 is transformed, for example, expansion or contraction.

In FIG. 2D, the second substrate 110 is assembled to the first substrate 102 to form a fluid injection device. In one embodiment, the second substrate 110 is disposed on the first substrate 102 followed by curing the channel wall 104 by UV light to assemble the first and second substrates 102 and 110. After assembly, the deformable layer 112 is in the fluid channel 106 and between the first and second substrates 102 and 110 and correspondingly on the actuator 108.

FIG. 2E is a sketch view of the fluid injection device according to the first embodiment of the invention. A channel wall 104 is formed on a first substrate 102. An actuator 108 is between the channel walls 104. Next, a second substrate 110 is disposed on the first substrate 102 to form a fluid channel 106 and a nozzle 114 therebetween.

FIG. 2F is a cross section of the fluid injection device taken on a line A-A′ in FIG. 2E. In FIG. 2F, a first substrate 102 is provided with an actuator 108. A second substrate 110 is disposed on the first substrate 102 to form a nozzle 114, in which a first electrode 116, a deformable layer 112 and a second electrode 118 is formed on a surface of the second substrate 110 to constitute a deformable unit 119 corresponding to the actuator 108. In deformable unit 119, the deformable layer 112 is formed on the second substrate 110 and covers the first electrode 116. The second electrode 118 is formed on the second substrate 110 and electrically connects to the deformable layer 112 by a fluid subsequently formed. Next, the fluid 126 is provided between the first substrate 102 and second substrate 110 and surrounds the actuator 108 and deformable unit 119.

Note that the first electrode 116 is directly in contact with the deformable layer 112 and the second electrode 118 is exposed in the fluid 126. Because the fluid 126 is an electrolyte such as ink, the second electrode 118 can electrically connect to the deformable layer 112 and along with the first electrode 116 constitute an electrical route for controlling the volume transformations of the deformable layer 112.

In one embodiment, when a fluid injection device 130, as shown in FIG. 2F, is operated, the first electrode 116 and the second electrode 118 may respectively provide ions to the deformable layer 112 and the fluid 126 for oxidation or reduction of the deformable layer 112, so that the deformable layer 112 transforms from an original first volume 120 to a second volume 122 by expansion. Then, a bubble 124 is generated by the actuator 108, and the second volume 122 of the deformable layer 112 may suppress the dimensions of the bubble 124 to control the size, dimension and flow of a droplet 128 ejected from nozzle 140 of the fluid injection device 130.

In this example, the deformable layer is formed on the second substrate and corresponding to the actuator on first substrate. It is appreciated that the deformable layer may be formed on the first substrate or second substrate between the actuator and the nozzle to change the geometric size of the fluid channel for controlling the size, dimension and flow of the droplet.

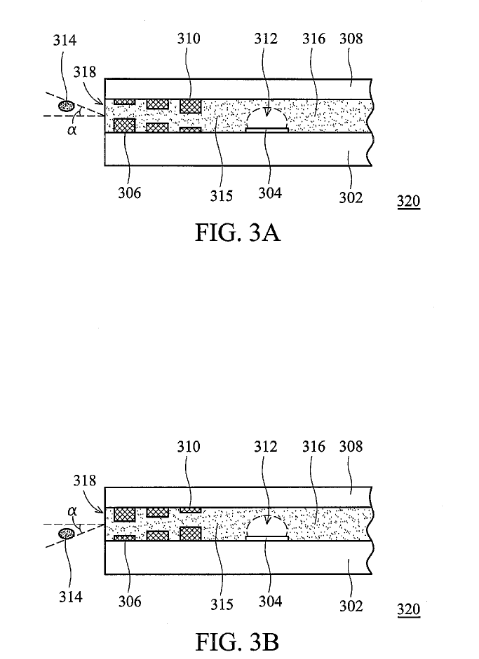

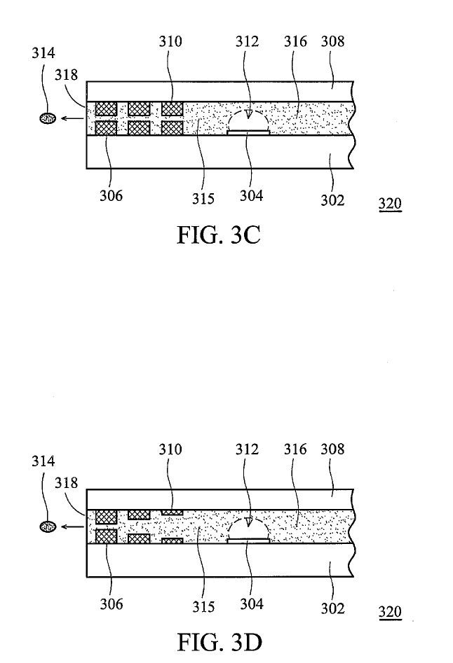

FIGS. 3A through 3D are cross sections of a method for fabricating and operating a fluid injection device according to a second embodiment of the invention. In these drawings, however, the electrode is not illustrated, but the deformable unit comprises at least one electrode and a deformable layer. The formation and material may be the same as the first embodiment, thus, similar detailed descriptions will not be further provided.

FIG. 3A is a cross section of a fluid injection device 320 according to the second embodiment of the invention. A first substrate 302 is provided with an actuator 304 and a first deformable unit 306 formed thereon. Next, a second substrate 308, on which a second deformable unit 310 is formed, is disposed on the first substrate 302 and the second deformable unit 310 is correspondingly formed on the first deformable unit 306. Thereafter, a fluid 316 is provided in a fluid channel 315 between the first substrate 302 and the second substrate 308 to complete the fluid injection device 320.

In some embodiment, a volume (after deformation) of the first deformable unit 306 gradually decreases from the nozzle 318 to the actuator 304, and a volume (after deformation) of the second deformable unit 310 gradually increases from the nozzle 318 to the actuator 304 by oxidation or reduction of the first deformable unit 306 and the second deformable unit 310 to change a flow direction of the fluid 316 in the fluid channel 315. That is, a top surface of the first deformable unit 306 has a height gradually decreased from the nozzle 318 to the actuator 304 and a top surface of the second deformable unit 310 has a height gradually increased from the nozzle 318 to the actuator 304 to change a flow direction of a bubble 312 in the fluid channel 315 for controlling a direction of an ejected droplet 314.

When the fluid injection device 320 is operated, the bubble 312 is generated by the actuator 304 and its flow direction is changed by the first deformable unit 306 and the second deformable unit 310, which is deformed, so that the droplet 314 with a direction is ejected from the nozzle 318 of the fluid injection device 320 in an a angle upward, as shown in FIG. 3A.

In FIG. 3B, the first deformable unit 306 and the second deformable unit 310 is operated by oxidation or reduction, so that a volume (after deformation) of the first deformable unit 306 gradually increases from the nozzle 318 to the actuator 304, and a volume (after deformation) of the second deformable unit 310 gradually decreases from the nozzle 318 to the actuator 304 to change the flow direction of the bubble 312 in the flow channel 315.

When the fluid injection device 320 is operated, the bubble 312 is generated by the actuator 304 and passes through the fluid channel 315, of which the wall profiles are changed by the first deformable unit 306 and the second deformable unit 310, so that the droplet 314 with a direction is ejected from the nozzle 318 of the fluid injection device 320 in an a angle downward, as shown in FIG. 3B.

Specifically, in the fluid injection device 320, as shown in FIG. 3B, a top surface of the first deformable unit 306 (after deformation) has a height gradually increased from the nozzle 318 to the actuator 304, and a top surface of the second deformable unit 310 (after deformation) has a height gradually decreased from the nozzle 318 to the actuator 304 to change the flow direction of the bubble 312 in the fluid channel 315, and further eject the droplet 314 with a direction.

In these examples, the first deformable unit 306 is controlled to transform from an original first volume to a second volume with a non-planar top surface, and the second deformable unit 310 is controlled to transform from an original first volume to a second volume with a non-planar top surface. An equidistant channel is formed between the non-planar top surfaces of the second volumes of the first deformable unit 306 and the second deformable unit 310 to control an ejected direction of the droplet 314.

In one embodiment as shown in FIG. 3C, the first deformable unit 306 and the second deformable unit 310 are controlled by oxidation or reduction to transform both unit to the second volumes substantially the same as each other. Specifically, a top surface (after deformation) of the first deformable unit 306 and a top surface (after deformation) of the second deformable unit 310 is substantially planar, and further changes the dimension and size of the bubble 312 generated by actuator 304 in the fluid channel 315 to control the dimension and speed of the droplet 314 ejected from the nozzle 318.

In this example, the first deformable unit 306 and the second deformable unit 310 are operated to form a suitable distance between the top surfaces thereof by oxidation or reduction. Accordingly, a geometric size of the fluid channel 315 close to the nozzle 318 is changed to control the ejected flow of the droplet 314 in fluid injection device 320.

In FIG. 3D, the first deformable unit 306 and the second deformable unit 310 are operated, so that the second volume of the first deformable unit 306 gradually decreases from the nozzle 318 to the actuator 304 and the second volume of the second deformable unit 310 gradually decreases from the nozzle 318 to the actuator 304 to change a diameter distribution of the fluid channel 315. Specifically, the top surface of the first deformable unit 306 has a height gradually decreased from the nozzle 318 to the actuator 318, and the top surface of the second deformable unit 310 has a height gradually decreased from the nozzle 318 to the actuator 318, so that the geometric size of the fluid channel 315 gradually shrinks from the actuator 304 to the nozzle 318 to increase an ejected speed of the droplet 314 in the fluid injection device 320.

In the example as shown in FIG. 3D, the first deformable unit 306 is operated to transform to a second volume with a non-planar top surface and the second deformable unit 310 is operated to transform to a second volume with a non-planar top surface. An unequidistant channel is formed between the non-planar top surfaces of the first deformable unit 306 and the second deformable unit 310 to control the ejected speed and the flow of the droplet 314. Because the ejected speed of the droplet is increased and the first and the second deformable units with a relatively high top surface close to the nozzle decreases remnant droplets, thus, the inkjet printing quality is improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid injection device, comprising:
a first substrate having an actuator thereon;
a second substrate correspondingly disposed on the first substrate to form a nozzle;
a first deformable unit having a first volume between the first substrate and the second substrate; and
a fluid sandwiched between the first substrate and the second substrate and surrounding the first deformable unit and the actuator.

2. The device as claimed in claim 1, wherein the first deformable unit comprises:
a first electrode disposed on the second substrate;
a first deformable layer formed on the second substrate and covering a portion of the first electrode; and
a second electrode disposed on the second substrate and electrically connected to the first deformable layer by the fluid.

3. The device as claimed in claim 1, wherein the first deformable unit comprises:
a first electrode disposed on the first substrate;
a first deformable layer formed on the first substrate and covering a portion of the first electrode; and
a second electrode disposed on the first substrate and electrically connected to the first deformable layer by the fluid.

4. The device as claimed in claim 2, further comprising a second deformable unit disposed on a region adjacent to the nozzle and corresponding to the first deformable unit.

5. The device as claimed in claim 4, wherein the second deformable unit comprises:
a third electrode disposed on the first substrate,
a second deformable layer formed on the first substrate and covering a portion of the third electrode; and
a forth electrode disposed on the first substrate and electrically connected to the second deformable layer by the fluid.

6. The device as claimed in claim 5, wherein the first deformable layer and the second deformable layer comprises a conducting polymer.

7. The device as claimed in claim 5, wherein the first deformable layer and the second deformable layer comprises polypyrrole, polyaniline, polysulfone, polythiophenes or polyacetylene.

8. A method for fabricating a fluid injection device, comprising:
providing a first substrate having an actuator thereon;
disposing a second substrate on the first substrate to form a fluid channel and a nozzle;
forming a deformable unit in the fluid channel; and
providing a fluid in the fluid channel and surrounding the first deformable unit and the actuator.

9. The method as claimed in claim 8, wherein forming the first deformable unit comprises:
forming a first electrode on the second substrate;
forming a first deformable layer on the second substrate and covering a portion of the first electrode; and
forming a second electrode on the second substrate and electrically connected to the first deformable layer.

10. The method as claimed in claim 9, wherein the first deformable layer is formed by dip coating, spin coating or electrchemical deposition.

11. The method as claimed in claim 9, wherein the first deformable layer is formed by electroploymerization or inkjet printing.

12. The method as claimed in claim 9, further comprising forming a second deformable unit on a region adjacent to the nozzle and corresponding to the first deformable unit.

13. The method as claimed in claim 12, wherein forming the second deformable unit comprises:
forming a third electrode on the first substrate;
forming a second deformable layer on the first substrate and covering a portion of the third electrode; and
forming a forth electrode on the first substrate and electrically connected to the second deformable layer.

14. A method for operating a fluid injection device comprising a fluid surrounding a first deformable unit and an actuator, the method comprising:
providing a pressure to the fluid by the actuator to eject a droplet; and
transforming the first deformable unit from a first volume to a second volume to control an ejected direction, flow or speed of the droplet.

15. The method as claimed in claim 14, wherein transforming the first deformable unit comprises:
providing a first ion having a first polarity to a first deformable layer by a first electrode;
providing a second ion having a second polarity to the fluid surrounding the first deformable unit by a second electrode; and
oxidizing or reducing the first deformable layer to transform the first deformable layer from a first volume to a second volume.

16. The method as claimed in claim 14, further comprising disposing a second deformable unit corresponding to the first deformable unit.

17. The method as claimed in claim 16, wherein controlling the droplet comprises:
operating the first deformable unit and the second deformable unit to form an equidistant channel therebetween to control an ejected direction or flow of the droplet.

18. The method as claimed in claim 16, wherein controlling the droplet comprises:
operating the first deformable unit to transform from the first volume to the second volume with a non-planar top surface;
operating the second deformable unit to transform from a first volume to a second volume with a non-planar top surface; and
forming an equidistant channel between the non-planar top surfaces of the second volumes of the first deformable unit and the second deformable unit to control an ejected direction or size of the droplet.

19. The method as claimed in claim 16, wherein controlling the droplet comprises:
operating the first deformable unit to transform from the first volume to the second volume with a non-planar top surface;
operating the second deformable unit to transform from a first volume to a second volume with a non-planar top surface; and
forming an unequidistant channel between the non-planar top surfaces of the second volume of the first deformable unit and the second deformable unit to control an ejected speed or size of the droplet.

20. The method as claimed in claim 14, wherein the second volume of the first deformable unit changes the dimensions of a bubble generated by the actuator to control an ejected direction or size of the droplet.
